(19) United States
(12) Patent Application Publication
(10) Pub. No.: US 2024/0276344 A1
(43) Pub. Date: Aug. 15, 2024

(54) SELF-GOVERNING WIRELESS COMMUNICATIONS SYSTEM

(71) Applicant: BOSS PACKAGING INC., Calgary (CA)

(72) Inventors: ANTHONY BASTIAANSEN, Calgary (CA); THAI BICH TRAN, Calgary (CA)

(21) Appl. No.: 18/290,129

(22) PCT Filed: May 19, 2022
(86) PCT No.: PCT/CA2022/050798

§ 371 Date: Nov. 9, 2023

Related U.S. Application Data
(60) Provisional application No. 63/190,511, filed on May 19, 2021.

(51) Int. Cl. H04W 40/24; H04W 64/00; H04W 84/20; H04W 88/16

(52) U.S. Cl. CPC H04W 40/248; H04W 64/00; H04W 84/20; H04W 88/16

(57) ABSTRACT

A communications system includes: a plurality of nodes distributed within a geographical area, each of the plurality of nodes being in communication with one or more of the other of the plurality of nodes to collectively form at least a partially-connected wireless mesh network; and each of the plurality of nodes having: a node processor; a battery; a connection to a power source; a short-range transceiver for short-range communications between nodes of the plurality of nodes; and a long-range transceiver for long-range communication with a long-range network; and in which each of the plurality of nodes are configured to dynamically assign and use one or more of the plurality of nodes as a border router.

### TECHNICAL FIELD

The present document relates to self-governing wireless communications systems and, in one example, to a wireless network of node-to-node communications for use on railway lines in remote regions where other forms of wireless communication are unavailable.

### BACKGROUND

The following paragraphs are not an admission that anything discussed in them is prior art or part of the knowledge of persons skilled in the art.

Wireless mesh networks have been used for railway video surveillance, on-board systems communication, and troubleshooting. Remote areas pose a challenge for traditional networks to avoid the perils and uncertainties of gaps in cellular or other long-range communication networks.

### SUMMARY

A communications system is disclosed comprising: a plurality of nodes distributed within a geographical area, each of the plurality of nodes being in communication with one or more of the other of the plurality of nodes to collectively form at least a partially-connected wireless mesh network; and each of the plurality of nodes having: a node processor; a battery; a connection to a power source; a short-range transceiver for short-range communications between nodes of the plurality of nodes; and a long-range transceiver for long-range communication with a long-range network; and in which each of the plurality of nodes are configured to dynamically assign and use one or more of the plurality of nodes as a border router.

A method is disclosed comprising: using a plurality of nodes to communicate with each other in a partially-connected mesh network and dynamically assign one or more of the plurality of nodes as a border router, in which the plurality of nodes are distributed within a geographical area; and using the border router to relay communications from the plurality of nodes through the long-range network.

A communications system, according to the present disclosure, has a plurality of trackside nodes, arranged alongside a railway line, each in communication with at least one other of the plurality of nodes. A plurality of gateway routers installed periodically adjacent to the railway line, to facilitate communication between one or more nodes and a long-range network.

In another embodiment, each node has a first wireless transceiver for short distance communication and a second wireless transceiver for long distance communication. The system software gathers information on performance factors to evaluate each node and determine which nodes will communicate both with other nearby nodes and with the long-range network, in place of the plurality of gateway routers.

In another embodiment, the performance factors are one or more factors selected from the group consisting of: battery performance, number of other nodes in communication range, cellular signal strength, number of other nearby candidate uplink nodes, and distance to the nearest suitable candidate uplink node.

In another embodiment, the first transceiver is a low frequency radio transceiver, for example an IEEE™ 802.15.4E 2.4 GHz wireless transceiver, a 2GFSK transceiver or a device that operates using other protocols.

In various embodiments, there may be included any one or more of the following features: The plurality of nodes comprise one or more gateway routers. The one or more gateway routers are characterized by superiority relative to the other of the plurality of nodes, of one or more of battery performance, long-range link quality, power source capacity, power source permanence, and a wired connection to the long-range network. In a first mode, each of the plurality of nodes assign and use one or more gateway routers as the border router in preference to the other of the plurality of nodes. In a second mode, each of the plurality of nodes assign and use another of the plurality of nodes as a border router when a ranking of the gateway router drops below a predetermined threshold or a ranking of the another of the plurality of nodes. Each of the plurality of nodes are configured to dynamically assign a border router for the node based on rankings dynamically assigned to each of the plurality of nodes. A ranking of each node is based on one or more of the following performance characteristics: a battery capacity, battery performance, available charging capacity, long-range link quality, microcontroller unit (MCU) utilization, number of other nodes in communication range with the node, number of other nearby candidate border routers, distance to the nearest suitable candidate border router, long-range network load, and short-range bandwidth. The ranking of each node is based on at least battery capacity, available charging capacity, and long-range link quality. Each of the plurality of nodes are configured to broadcast, to other of the plurality of nodes, performance characteristics of the node at periodic intervals or as a result of a change in performance characteristics. Each of the plurality of nodes are configured to self-rank and broadcast a self-ranking for the node to other of the plurality of nodes. Each of the plurality of nodes are configured to dynamically assign and use one or more of the plurality of nodes as a border router based on the rankings provided by each of the plurality of nodes and a short-range link quality to each of the plurality of nodes. There are a plurality of border routers available for a node; and the plurality of nodes are configured to failover to other of the plurality of border routers when a first of the plurality of border routers is instructed, and fails, to send a long-range transmission through the long-range network. In the event of a border router being instructed, and failing, to send data through the long-range network, one or more of the plurality of nodes storing and subsequently re-attempting to send or instruct the sending of the data. The power source of one or more of the plurality of nodes comprises a low-watt power source. The power source has an average energy production capacity of 15 W/hr or less daily. The power source comprises a solar panel. Each of the plurality of nodes comprises a housing and is mounted above-ground on a pole. The long-range wireless network comprises one or more of the internet, a cellular network, and a satellite network. The geographical area comprises a transport corridor. The transport corridor comprises a railway track for a train. The plurality of nodes are configured to maintain a train on the railway track in continuous communication with the long-range wireless network. The geographical area comprises a remote geographical area with portions or the entirety of which being out of contact with a cellular network other than via one or more border routers. The long-range transceiver comprises one or more of: a cellular transceiver, a satellite transceiver, a broadcast radio transceiver, and a microwave transceiver. The short-range transceiver comprises one or more of a low frequency radio transceiver, an infrared transceiver, a Bluetooth transceiver, a Wi-Fi transceiver, and a mesh network transceiver. The short-range transceiver comprises a low frequency radio transceiver, such as a 2.4 GHz or 915 MHz wireless transceiver. A back-end system comprising a server processor connected to receive and transmit communications from and to, respectively, the plurality of nodes via the long-range network. The server processor is connected to serve and relay communications information from the plurality of nodes to third parties via the long-range network. A plurality of sensors connected to provide information to the plurality of nodes. The plurality of sensors are configured to sense and provide information on one or more of motion, temperature, vibration, tilt, rail or corridor integrity, seismic activity, humidity, water levels, weather, flooding, proximity, obstacle, wildlife, sound and visual elements. The plurality of nodes comprise one or more gateway routers; in a first mode, each of the plurality of nodes assign and use one or more gateway routers as the border router in preference to the other of the plurality of nodes; and in a second mode, each of the plurality of nodes assign and use another of the plurality of nodes as a border router when a ranking of the gateway router drops below a predetermined threshold or a ranking of the another of the plurality of nodes. E each of the plurality of nodes are configured to dynamically assign a border router for the node based on rankings dynamically assigned to each of the plurality of nodes. Each of the plurality of nodes broadcasting, to other of the plurality of nodes, performance characteristics of the node at periodic intervals or as a result of a change in performance characteristics. Each of the plurality of nodes self-ranking itself and broadcasting a self-ranking for the node to other of the plurality of nodes. At one of the plurality of nodes: assigning one of the other of the plurality of nodes as a border router based on the rankings provided by each of the plurality of nodes and a short-range link quality to each of the plurality of nodes; and transmitting a message to the border router. There are a plurality of border routers available for a node, and further comprising: attempting to transmit data by one of the plurality of border routers; and in the event of failure, attempting to transmit data by subsequent of the plurality of border routers. In the event of no other suitable border router being located or all possible border routers failing to transmit the data, storing and subsequently re-attempting to send or instruct the sending of the data. The plurality of nodes cooperate to collectively assign rankings to each node. The plurality of nodes collectively form a self-healing wireless mesh network. The low-watt power source has a wattage of 50 watts or less. Transmitting a message off-network through the long-range network via a border router.

The foregoing summary is not intended to summarize each potential embodiment or every aspect of the subject matter of the present disclosure. These and other aspects of the device and method are set out in the claims.

### BRIEF DESCRIPTION OF THE FIGURES

Embodiments will now be described with reference to the figures, in which like reference characters denote like elements, by way of example, and in which:

FIG. 1 is a schematic view of a communications system, illustrating a track-side wireless mesh network communicating with a locomotive in a remote geographical area with gaps in cellular coverage.

FIG. 2 is a block diagram of the modules of software used by a node from the communications system of FIG. 1.

FIG. 3 is a block diagram of the infrastructure of the wireless mesh network of FIG. 1.

FIG. 4 is a block diagram of the components of a node of the communications system of FIG. 1.

FIG. 5 is a flow diagram of a self-ranking process carried out by a node of the communications system of FIG. 1.

FIG. 6 is a flow diagram of a border router selection process carried out by a node of the communications system of FIG. 1.

FIG. 7 is a flow diagram of a communication selection process carried out by a node of the communications system of FIG. 1.

FIG. 8 is a front perspective view of a node of the communications system of FIG. 1.

FIG. 9 is a side elevation view of the node of FIG. 8 mounted on a track-side pole with a solar panel connected to charge a battery of the node.

FIG. 10 is a rear perspective view of the node of FIG. 8.

FIG. 11 is a bottom perspective view of the node of FIG. 8.

FIG. 12 is a rear perspective view of the node of FIG. 8 with an outer housing door opened.

FIG. 13 is a rear elevation view of the node of FIG. 8 with the outer housing door opened.

FIG. 14 is a front perspective view of an internal housing of the node of FIG. 8.

FIG. 15 is a rear perspective view of the internal housing of FIG. 14.

FIG. 16 is a front elevation view of the internal housing of FIG. 14.

FIG. 17 is a side elevation view of the internal housing of FIG. 14.

FIG. 18 is a rear elevation view of the internal housing of FIG. 14.

FIG. 19 is a bottom plan view of the internal housing of FIG. 14.

FIG. 20 is a partially exploded view of the internal housing of FIG. 14, illustrating internal components of the node.

FIG. 21 is a rear elevation view of the internal housing of FIG. 14, with a rear cover removed.

### DETAILED DESCRIPTION

Immaterial modifications may be made to the embodiments described here without departing from what is covered by the claims.

Remote geographical areas exist where gaps in cellular or satellite networks (or other long-range networks) make long-range communications difficult or impossible. Many industrial operations, such as rail, mining, pipeline, harvesting, and others, are carried out in remote geographical areas, such as remote forests, mountain ranges, waterways, plains, or other topographies. Communications in such cases may be difficult, expensive, and time-delayed, and in some cases impossible. There are advantages in being able to permit real-time and/or continuous communications with remote or far-away areas, for example, the ability the monitor and respond quickly to changing conditions, weather, situations, and emergencies, and the ability to maximize efficiency of operations. Remote train lines are no exception to these issues. Many remote train lines are cut off from traditional communication lines, resulting in situations where a passing train may be out of communications with headquarters for an extended period of time. In such a situation, any major (such as an emergency, for example a derailment) or even minor (such as a rail blockage or weather obstruction) occurrence may be difficult to detect, trouble-shoot, and satisfactorily address, potentially leading to line delays, unexpected expenses, and in extreme cases catastrophic losses due to cascading events.

A mesh network may be used for local and in some cases external communications in an area. A mesh network (or simply meshnet) may comprise a local area network topology in which the infrastructure nodes (i.e., bridges, switches, and other infrastructure devices) connect directly, dynamically and non-hierarchically to as many other nodes as possible and cooperate with one another to efficiently route data to and from clients. A wireless network may comprise an infrastructure made up of devices that are wirelessly coupled to each other. The devices may help forwarding packets for one another so that the network can cover a larger area without the user needing to set up a dedicated infrastructure or wired connection for each device. The lack of dependency on one node, and decentralized decision-making and node cooperation may allow for every node to potentially participate in the relay of information. Mesh networks may dynamically self-organize and self-configure, which can reduce installation overhead. The ability to self-configure enables dynamic distribution of workloads, particularly in the event a few nodes should fail. This in turn contributes to fault-tolerance and reduced maintenance costs. Mesh topology may be contrasted with conventional star/tree local network topologies in which bridges/switches are directly linked to only a small subset of other bridges/switches, and the links between these infrastructure neighbours are hierarchical. While star-and-tree topologies are very well established, highly standardized and vendor-neutral, vendors of mesh network devices have not yet all agreed on common standards, and interoperability between devices from different vendors is not yet assured.

Mesh networks may relay messages using either a flooding technique or a routing technique which makes them different from non-mesh networks. With routing, the message may be propagated along a path by hopping from node to node until it reaches its destination. To ensure that all its paths are available, the network may allow for continuous connections and must reconfigure itself around broken paths, using self-healing algorithms such as Shortest Path Bridging and TRILL (Transparent Interconnection of Lots of Links). Self-healing allows a routing-based network to operate when a node breaks down or when a connection becomes unreliable. As a result, the network may be quite reliable, as there is often more than one path between a source and a destination in the network. Although mostly used in wireless situations, this concept can also apply to wired networks and to software interaction.

Mesh networks may have a variety of features and parts. A mesh network whose nodes are all connected to each other is a fully connected network. Fully connected wired networks have the advantages of security and reliability—problems in a cable affect only the two nodes attached to it. However, in such networks, the number of cables, and therefore the cost, goes up rapidly as the number of nodes increases. By contrast, in a partially connected network, nodes may be connected to neighbouring or adjacent nodes, creating a subnet, but without direction connections with all other nodes in the network. Mesh networks may contain one or more of gateways or border routers, mesh devices or routers, and leaf devices. A border router, sometimes interchangeably referred to as a gateway router, may be the interface to the outside world, and may connect the wireless mesh network to a building Ethernet, or connecting to a cloud service via Internet, for instance via LTE (Long Term Evolution) or 3G. A mesh device may be a device that helps build up the actual mesh, and may act to forward, or route, data to and from other nodes hence being the mesh backbone. Leaf devices may be devices that are part of the mesh network, but do not help creating the infrastructure. Such may not forward traffic on behalf of others, but may communicate via the network. Leaf devices are often devices that needs to conserve energy due to constraints on battery. In a wired mesh, shortest path bridging and TRILL, may each allow Ethernet switches to be connected in a mesh topology, and allow for all paths to be active. IP (Internet Protocol) routing may support multiple paths from source to destination.

A wireless mesh network (WMN) may be a network made up of radio nodes organized in a mesh topology. Such may also be a form of wireless ad hoc network. In telecommunications networks, a node (Latin: nodus, ‘knot’) may be either a redistribution point or a communication endpoint. The definition of a node depends on the network and protocol layer referred to. A physical network node may be an electronic device that is attached to a network, and is capable of creating, receiving, or transmitting information over a communication channel. A passive distribution point such as a distribution frame or patch panel may consequently not be a node. Radio communication may be the technology of signaling and communicating using radio waves. Radio waves include electromagnetic waves of frequency between 30 hertz (Hz) and 300 gigahertz (GHz). Such may be generated by an electronic device called a transmitter connected to an antenna which radiates the waves, and received by another antenna connected to a radio receiver. Radio is very widely used in modern technology, in radio communication, radar, radio navigation, remote control, remote sensing, and other applications. A wireless mesh may be self-healing if it can automatically repair itself when the environment changes. It could for instance be that a link between two nodes that worked perfectly fine an hour ago is now blocked by a bookshelf, a truck, or a steel door. The network will then automatically, without the involvement of any user, change its topology to be able to route the traffic a different path.

Mesh networks may have various advantages and disadvantages. In a full mesh or fully connected mesh network, the nodes within the network may be connected with every other. For example, if there are n number of nodes during a network, each node will have an n−1 number of connections. A full mesh provides an excellent deal of redundancy, but because it is prohibitively expensive to implement, it's usually reserved for network backbones. The partial mesh may be more practical as compared to the full mesh. In a partially connected mesh, all the nodes aren't necessary to be connected with one another during a network. Peripheral networks are connected using partial mesh and work with a full-mesh backbone in tandem. Advantages of Mesh Topology may include one or more of a) failure during a single device won't break the network, b) there may be no traffic problem as there is a dedicated point to point links for every computer, c) fault identification is straightforward, d) the topology provides multiple paths to succeed in the destination and tons of redundancy, e) such provides high privacy and security, f) data transmission is more consistent because failure doesn't disrupt its processes, g) adding new devices won't disrupt data transmissions, h) the topology has robust features to beat any situation, and i) a mesh doesn't have a centralized authority. Disadvantages of Mesh Topology include one or more of: a) may be costly as compared to the opposite network topologies i.e. star, bus, point to point topology, b) installation is extremely difficult in the mesh, c) power requirement is higher as all the nodes will need to remain active all the time and share the load, d), complex processes are needed, and complex algorithms, e) the cost to implement mesh is above other selections, f) there is a high risk of redundant connections, g) each node requires a further utility cost to think about, and h) maintenance needs are challenging with a mesh.

Embodiments of this disclosure may include protocols that aim to create a reliable, reactive, and power efficient system for a low power wireless communication network in remote area where infrastructure for constant power and hi-speed internet is not available. Such protocols may aim to solve the challenges of wireless communication over a long linear infrastructure such as rail tracks, mining conveyor, pipe line where power options are limited, and where mainstream communication modes, such as cellular network, satellite network are spotty, expensive, or non-existent. In some cases, the systems disclosed herein may be used on any communication applications, whether residential, industrial, remote, urban or other variety. Such protocols may dynamically allocate higher energy communications to adapt to the local limitations created by the variation of natural sources of power such as solar and wind over long distance, linear infrastructure and selects the most power smart communication mode in real time. Such protocols may be used as an application layer for any low power wireless mesh network. A core component of some of these protocols is the dynamic assignment of a border router role based on the availability of energy, wireless wide-area network (WWAN) link quality, low power wireless mesh network link quality and microcontroller unit (MCU) utilization of the node for any smart nodes on the network.

A communications system, according to the present disclosure, may provide a cost-effective overlay system for remote communications and data transfer. The system may be used to transfer data from a locomotive or other railway or trackside equipment to data processing centres for analytics. The system may also be used for point-to-train communications in remote areas where other forms of wireless communications, such as cellular networks, are unavailable.

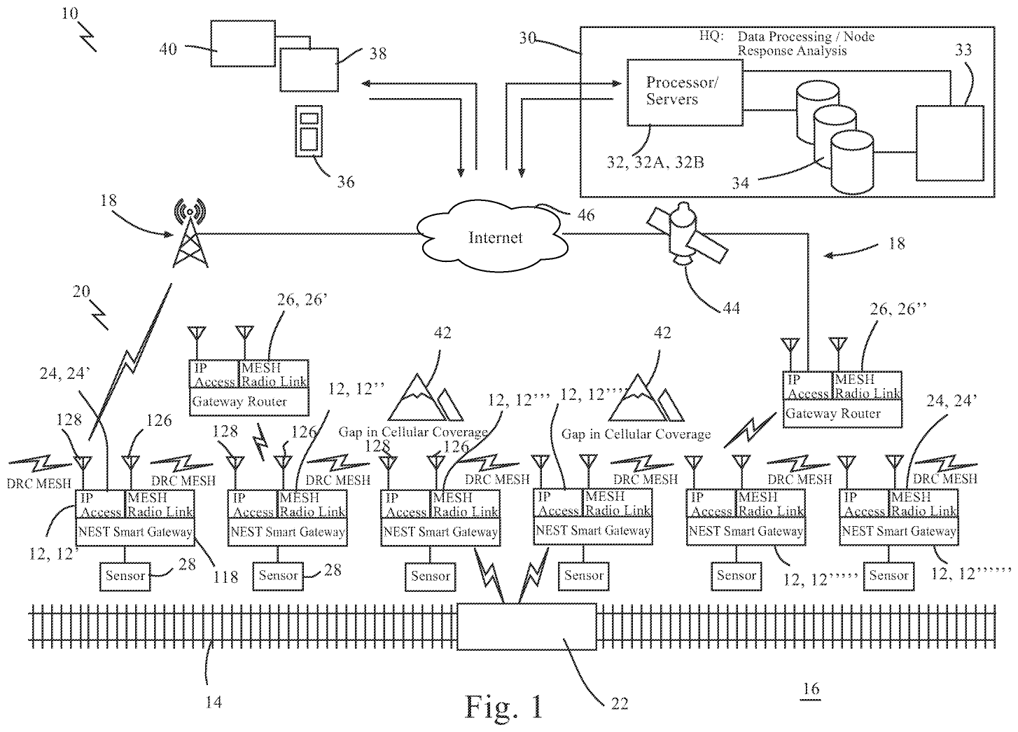

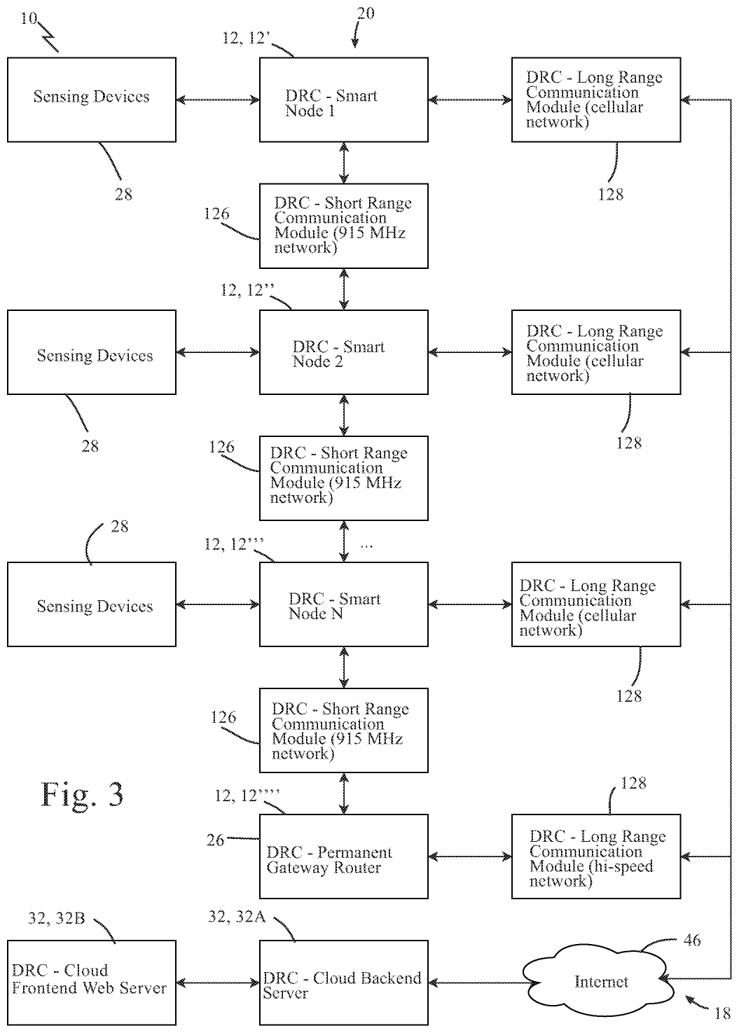

Referring to FIG. 1, a communications system 10 is illustrated comprising a plurality of nodes 12. The plurality of nodes 12 may be distributed within a geographical area 16, such as a transport corridor as shown. Each of the plurality of nodes 12 may be in communication with one or more of the other of the plurality of nodes 12 to collectively form at least a partially-connected wireless mesh network 20. Referring to FIGS. 1 and 3, each of the plurality of nodes 12 may be configured for short-range, and in some cases long-range communications. Each node 12 may comprise one or more of a node processor 118, a battery 120, and a connection, such as connection 106, to a power source, such as a solar panel 130 (not shown). Each node 12 may comprise a short-range transceiver 126 for short-range communications between nodes 12 of the plurality of nodes 12. Each node 12 may comprise a long-range transceiver 128 for long-range communication with a long-range network 18, which may interface with and/or include the internet 46. Each of the plurality of nodes 12 may be configured to dynamically assign and use one or more of the plurality of nodes 12 as a border router 24. The plurality of nodes 12 may be, in use, used to communicate with each other in a partially-connected mesh network 20 and dynamically assign one or more of the plurality of nodes 12 as a border router 24. The border router 24 may be used to relay communications from the plurality of nodes 12 through the long-range network 18. The assignment of border routers 24 may be flexible and dynamic, and in some cases node-specific.

Referring to FIG. 1, the geographical area 16 may comprise a remote area. In some cases, the area 16 comprises a transport corridor 14, such as a railway track for a train 22. The plurality of nodes 12 may be configured to maintain the train 22 on the railway track in continuous communication with the long-range wireless network 18. In some cases, the nodes 12 may cooperate with sensors 28 to receive data about the train 22 and/or track, and relay that data off-site through the network 18, for example to an end user of a back-end system 30. The geographical area 16 may comprise a remote geographical area with portions or the entirety of which being out of contact with a cellular network (such as network 18) other than via one or more border routers 24, for example if one or more gaps 42 in network coverage are present along the corridor 14 or area 16.

Referring to FIGS. 1 and 3, the plurality of nodes 12 may comprise one or more gateway routers 26. The one or more gateway routers 26 may be characterized by superiority, for example in long-distance communications or power supply, relative to the other of the plurality of nodes 12. Superiority may be measured on the basis of one or more of battery performance, long-range link quality, power source capacity, power source permanence, and the existence if any of a wired connection to the long-range network 18. Mere preferable location may be sufficient to assign a particular node 12 as a gateway router 26. In a first mode, each of the plurality of nodes 12 may assign and use one or more gateway routers 26 as a border router 24 in preference to the other of the plurality of nodes 12. The first mode may be the default mode, or may be a mode selected when all other variables are neutral as between candidate border routers 24 or in favor of the gateway router 26. In a second mode, each of the plurality of nodes 12 or one or more of them may assign and use another (not the gateway router 26) of the plurality of nodes 12 as a border router 24, for example when a ranking of the gateway router 26 drops below a predetermined threshold or below a ranking of the another of the plurality of nodes 12, such as nodes 12′ and 12′″″ in the example of FIG. 1. It should be understood that in the drawings and description, the use of apostrophe suffixes (such as ′ or ″) on a reference character refers to a type of the part identified by the reference character, and references may be made in the description or drawings with or without the suffix, and refer to the same part in the drawings or description, without or with the suffix, respectively. In some cases, a gateway router 26 may have the same infrastructure and parts as a regular or average node 12, and in some cases as all of the nodes 12.

Referring to FIGS. 1 and 3, each of the plurality of nodes 12 may be configured to dynamically assign a border router 24 for the node 12. Assignment of a border router 24 may be based on rankings dynamically assigned to each of the plurality of nodes 12. A ranking of each node 12 may be based on one or more of the following performance characteristics: battery capacity, battery performance, available charging capacity, long-range link quality, microcontroller unit (MCU) utilization, number of other nodes in communication range with the node, number of other nearby candidate border routers, distance to the nearest suitable candidate border router, long-range network load, and short-range bandwidth. The ranking of each node 12 may be based on at least battery capacity, available charging capacity, and long-range link quality, in some cases.

Referring to FIGS. 1-3, each node 12 may be configured to broadcast status information about itself to other nodes 12, to be used to assign appropriate border routers 24 for each node 12. In some cases, each of the plurality of nodes 12 are configured to broadcast to other of the plurality of nodes 12 on performance characteristics of the node 12. Broadcasting by a node 12 may be carried out based on a suitable timing, such as at periodic intervals, according to a schedule, and/or as a result of a change in performance characteristics. In some cases, new rankings may be broadcasted at time intervals of an hour or less, for example 30 minutes or less, in some cases 10 minutes or less, or at other suitable intervals longer or shorter than the aforementioned examples. Each of the plurality of nodes 12 may be configured to self-rank and broadcast a self-ranking for the node 12 to other of the plurality of nodes 12. By self-ranking itself and broadcasting a self-ranking for the node 12 to other of the plurality of nodes 12, a node 12 may be efficiently providing sufficient information to nodes 12 to reduce analytical burdens on those other nodes 12 when self-assigning border routers 24. Each of the plurality of nodes 12 may be configured to dynamically assign and use one or more of the plurality of nodes 12 as a border router 24 based on the rankings provided by each of the plurality of nodes 12. Assignment may be based on both the self-rankings received from other nodes 12 and a short-range link quality between the respective nodes 12. Short-range link quality may be a function of a variety of suitable factors, such as historical message success rate, latency, network adjacency, and time since last advertisement. Once assignment of an appropriate border router 24 is achieved, a message may be transmitted by a node 12 to the border router 24. The message is then relayed by the border router 24 out of the network 20, for example to a long-range network 18 and beyond.

Referring to FIGS. 1 and 3, the nodes 12 may have suitable transceivers to enable short and long-range communications. Each node 12 may have a long-range transceiver 128. Transceiver 128 may comprise one or more of: a cellular transceiver, a satellite transceiver, a broadcast radio transceiver, and a microwave transceiver. The long-range wireless network 18 may comprise one or more of the internet 46, a cellular network 18, and a satellite network 44. The short-range transceiver 126 may comprise one or more of a low frequency radio transceiver, an infrared transceiver, a Bluetooth transceiver, a Wi-Fi transceiver, and a mesh network transceiver. In some cases, transceivers 126 and 128 are provided on the same part, for example as part of a multi-function transceiver system. The short-range transceiver 126 may communicate at suitable frequencies, for example as low frequency radio transceiver. The short-range transceiver 126 may communicate at suitable frequencies, and may comprise a 2.4 GHz or 915 MHz wireless transceiver. Other ranges may be used. Smart node transceivers 126 and 128 may include long-range high-power transceivers (i.e., WWAN) and short rang low power transceiver (i.e., for a low power wireless mesh network).

FIG. 3 illustrates a conceptual layout of the relationship and basic parts of the system 10. Referring to FIG. 3, each node 12 may be associated with one or more sensors 28. Each node 12 may be connected to receive data from a sensing device or device, such as a sensor 28. Sensors 28 may be configured to sense and provide information on one or more of motion, temperature, vibration, tilt, rail or corridor integrity, seismic activity, humidity, water levels, weather, flooding, proximity, obstacle, wildlife, sound and visual elements. The sensors 28 may be located on or adjacent the corridor 14, and/or on the train 22. In the example of FIG. 3, each node 12 may receive data from sensors 28, and may either communicate the data off-network via a respective on-board transceiver 128, or route the data to another suitable border router, such as gateway router 26 in the example shown, passing through one or more other nodes 12 in the process. The data may be ultimately sent via the network 18, for example the internet 46, to a suitable user, such as a back-end client, for example a back-end server 32. In the example shown, a back-end server 32A receives data, and a front-end server 32B relays, and/or analyzes and provides information via a front-end system accessible by an end user.

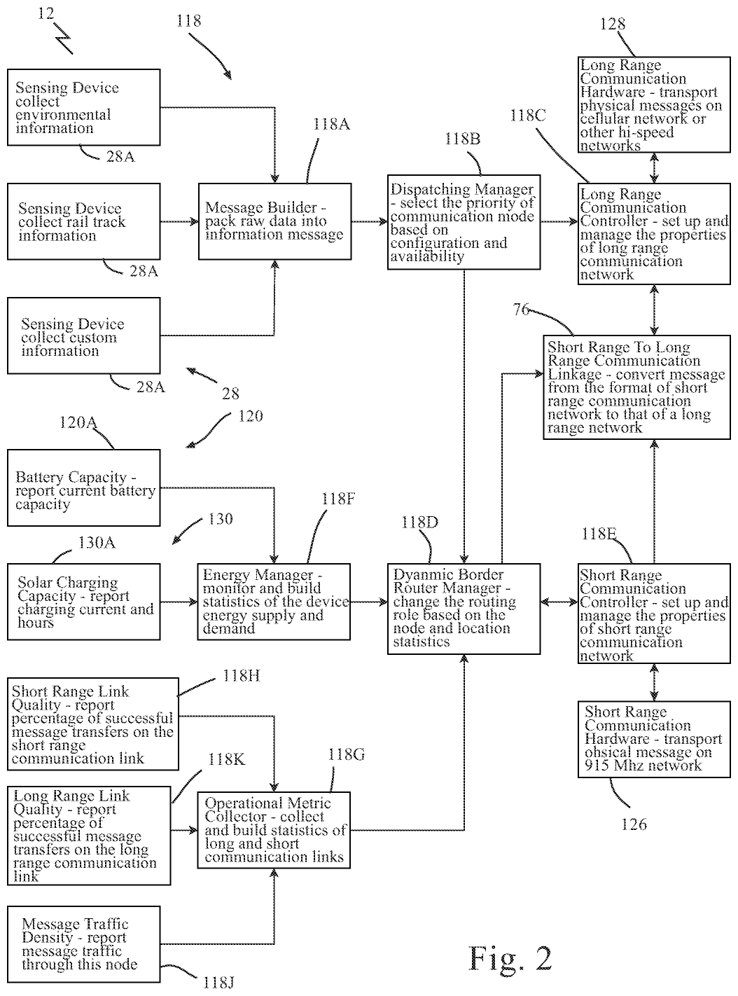

Referring to FIG. 2, each node 12 may carry out various functions and have various algorithms and parts in order to achieve such functions. Each of the boxes in FIG. 2 may refer to respective software modules, for example stored on a computer readable medium associated with or forming part of the processor 118, for example on a hard drive of a computer that defines processor 118. Each sensor 28 (nor shown) may be associated with a respective sensing device collector or reporter module 28A, which may be run either by the sensor 28 or the processor 118 of the node 12. The module 28A may convert sensor data into a usable or reportable format. Next, a message builder module 118A may compile and package a message, for example containing data from one or more sensors 28 in a reportable fashion. One prepared, the message packet is passed to a dispatching manager module 118B. The module 118B may be used to select the priority of communication mode based on various factors, such as configuration and availability of options. If the node 12 itself is suitable to act as a border router 24, the message may be delivered to a long-range communication controller module 118C, which may pass the message to long-range communication hardware, such as transceiver 128, where the message is passed outside the network 20 via the network 18. If the signal strength is too weak, or the message send fails or there is some other reason why the node 12 cannot function as a border router 24 in context, the message may be passed to another node 12 by short-range hardware such as a transceiver 126. A short-range to long-range communication linkage module 76 may be used to convert the form of message between short and long-range communication formats. The node 12 may select a suitable external border router 24 to send the message to, for example using a dynamic border router manager module 118D. The module 118D may consider various forms of information in making an assignment, for example the module 118D may communicate with one or more of an energy manager module 118F and an operation metric collector module 118G. The module 118F may receive and/or analyze and send information on energy-related aspects of the node 12, for example one or more of battery capacity information from a battery capacity reporter module 120A, and charging capacity information from a solar charging capacity reporter module 130A. The energy information may be used to self-assess the own nodes 12 suitability as a border router 24 and/or to rank the node 12 proportional to such suitability. The operation metric collector manager module 118G may receive information from suitable sources, such as one or more of a short-range link quality reporter module 118H, a long-range link quality reporter module 118K, and a message traffic density reporter module 118J. Each reporter module in this document may be connected to receive information from one or more devices, parts, or sensors to route and/or analyze and reformat such information for downstream uses. With the information in hand, the dynamic border router manager module 118D may make a suitable selection, or in some cases, assemble a priority list, of one or more border routers 24 to communicate with to send the requisite information into the long-range network 18. If the decision is made to send the data to another node 12 (for example border router 24), then the information may be passed to a short-range communication controller module 118E, and transmitted to such other node 12 via a short-range transceiver 126 or other suitable mechanism.

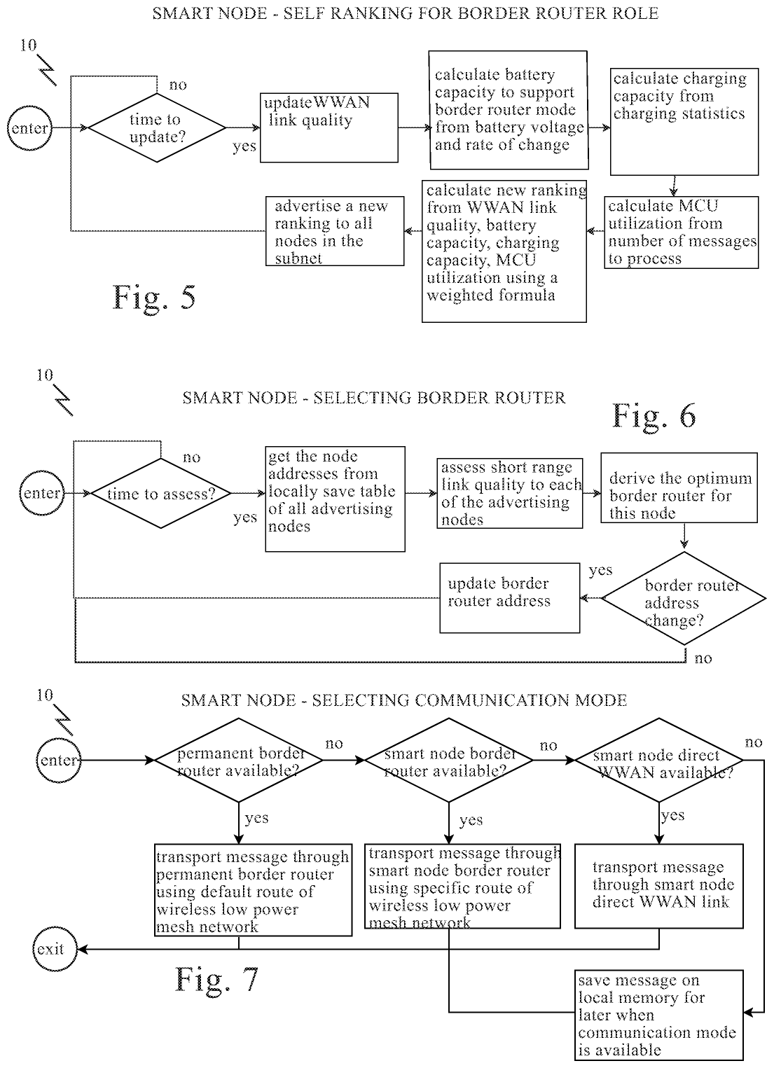

Referring to FIGS. 5-7, each node 12 may be configured to carry out and assist other nodes 12 to carry out, self-analysis and border router 24 assignment in a suitable fashion. Referring to FIG. 5, a method for self-ranking for border router 24 roles is shown, which may be carried out by individual nodes 12. Self-ranking for border router role may include the following: a smart node evaluates its own WWAN link, battery capacity (i.e., battery voltage, rate of change), charging capacity (i.e., hours of active charging, time of date), MCU utilization (i.e., how busy the MCU is, with lower utilization resulting in higher ranking). A node calculates its own border router role ranking using a custom weighted formula with all contributing parameters above. The custom formula is set according to the priority of each contributing factor for a specific application. In a first decision step, the node 12, for example the processor 118 for further example one or more modules used by the processor 118, may decide whether it is time to update the status of the node 12. As before, updating status may be done on an as-needed basis (for example in the event of a change of status or on some other occurrence of events), or according to a schedule, or according to an initiate status update request from on or off board the node 12. If it is time to update status, the node 12 may consider various factors by way of example. In the example shown, the node 12 may undergo a process step to calculate its on link quality, for example WWAN link quality review. A WWAN may refer to a wireless wide area network (WWAN), which is a form of wireless network. The larger size of a wide area network compared to a local area network requires differences in technology. Wireless networks of different sizes deliver data in the form of telephone calls, web pages, and video streaming. In other process steps (the order of process steps may be modified), battery capacity, charging capacity, MCU utilization, and other metrics, may be calculated. Table 1 below illustrates example data from such processes. In a subsequent process step, a new ranking may be calculated from the aforementioned metrics, for example using a weighted formula. An example calculation is shown below, based on respective scores for metrics, weighted and adjusted, normalized, and added together to assign a node ranking for that node 12. The resulting node score may be then broadcasted (advertised) to all other nodes 12 in the subnet, for example all nodes 12 in communication with the node 12. By advertising a change of border router ranking, the node advertises its new ranking to the rest of the subnet of the low power wireless mesh network. In a similar fashion, the node 12 will also receive rankings from other nodes 12 for purposes explained further below. Weightings may be adjusted to emphasize or de-emphasize various metrics.

TABLE 1
self-ranking metrics of a node 12

| | Example uses Node Address “3” | | | Weighted |
|---|---|---|---|---|
| | | Maximum | | Normalized |
| Node Border Router Eligibility Self Ranking | Score | Score | Weight | Score |
| Battery Capacity | 3 | 10 | 2 | 9 |
| Available Charging Capacity | 5 | 10 | 2 | 15 |
| Long-range Link Quality | 5 | 5 | 1 | 15 |
| MCU Availability | 4 | 5 | 0.5 | 6 |
| Long-range Network Load Availability | 3 | 5 | 0.5 | 5 |
| Short-range Network Load Availability | 2 | 5 | 0.5 | 3 |
| | | | 6.5 | 53 |

Referring to FIG. 6, a method of selecting a border router 24 at a node 12 is illustrated. To select a border router 24, the node 12 may keep a record of all high border ranking nodes in its subnet. The node then assesses the cost of sending data to the highest-ranking nodes. The node may select the lowest cost, highest ranking node to be its border router for transporting its messages out of the subnet. In a first decision step, the node 12 decides whether it is time to assess and assign a suitable border router or routers 24 for that node 12. A suitable time may be ad hoc, for example when the node 12 needs to send a message, or at periodic intervals or according to a schedule or external initiation request. If the decision is yes, the node 12 examines data and rankings from other local nodes in the next process step. Table 2 illustrates an example table of data that a node 12 might have to consider. In the example shown, the node 12 may carry out a process step of assessing short-range link quality with each candidate node 12 (candidate nodes 12 may be advertising nodes 12, for example nodes 12 in direct connection with the node 12, although this may not be required and other nodes in indirect (via routing) may be considered). In a further process step, the node 12 decides the optimum border router 24 for the node 12. As below and above, the node may consider self-rankings and link quality, determining a border router selection order or priority list as below in Table 2. Although a table is shown, the relevant information on nodes 12 may be stored and manipulated in any suitable format or arrangement. In the example shown, the most suitable border router 24 would be a node 12 at node address 2. If the node 12, in carrying out the analysis, has changed its assignment of border router 24 from last time, then the decision-making step reveals that the node 21 should update border router 24 address in its records. For subsequent messaging, whether by transmitting messages created by the node 12 or routed through the node 12 from another node 12, the node 12 may automatically rely on the assignment in the decision step of where to send the message. In some cases, border router 24 review and assignment is carried out prior to each message being sent.

TABLE 2
border selection table

| | Available Border Router Selection Table | | | |
|---|---|---|---|---|
| | Border | Short- | Border | Border |
| | Router | range | Router | Router |
| | Eligibility | Link | Selection | Selection |
| Node Address | Score | Quality | Rank | Order |
| 3 | 53 | 10 | 63 | 3 |
| 5 | 32 | 3 | 35 | 5 |
| 2 | 60 | 8 | 68 | 1 |
| 9 | 60 | 7 | 67 | 2 |
| 7 | 61 | 1 | 62 | 4 |

Referring to FIG. 7, a method of selecting a communication mode at a node 12 is illustrated. To select a communication mode, a node can choose one of the following communication mode based on the real time ranking of other nodes in the subnet. The method illustrated may be used as a failover method to ensure that a message is attempted a variety of ways to maximize the chance of successful transmission off network. The method may be used for providing further clarity to a node 12. In a first decision step, the node 12 reviews whether a permanent border router 26 is available. A gateway router 26 route may be given highest priority at the start. Transporting messages through the permanent border router using the default path of the low power wireless network when it is available, may be elected in priority of other options, as this may be the most power efficient communication mode. If available, the node 12 may transport the message through the permanent gateway router 26. If not, the node 12 may review whether a border router 24 is available. Transporting messages through the smart node with highest ranking for border router role when it is available, may allocate higher energy WWAN communications to the nodes that are best able to support it. The border router 24 may have been previously assigned via the process above, or another suitable process. If a suitable border router 24 is available, the message may be transported through that border router 24 via the short-range transmission protocol of the node 12. If no, the node 12 considers whether it can send the message itself. If so, the message is sent, for example using the node's long-range transceiver 128. If unable to send, the message may be stored, for example saved on local memory for later. If the message has been sent to another node for potential sending, and that sending has failed, the other node 12 may carry out a similar procedure to decide whether to save or which node 12 to send the message to. Storage may mean delaying options 1-3 until available. Referring to FIGS. 1 and 7, the system 10 may thus be configured for failover protocol. In some cases, there are a plurality of border routers 24 available for a node 12. The plurality of nodes 12 may be configured to failover to other of the plurality of border routers 24 when a first of the plurality of border routers is instructed, and fails, to send a long-range transmission through the long-range network 18. Thus, there may be an attempt to transmit data by one of the plurality of border routers 24, and in the event of failure, there may be an attempt to transmit the data by subsequent of the plurality of border routers 24. In some cases, the node 12 may follow the selection order determined in Table 2. In the event of no other suitable border router being located or all possible border routers failing to transmit the data, the node 12 may store and subsequently re-attempt to send or instruct the sending of the data.

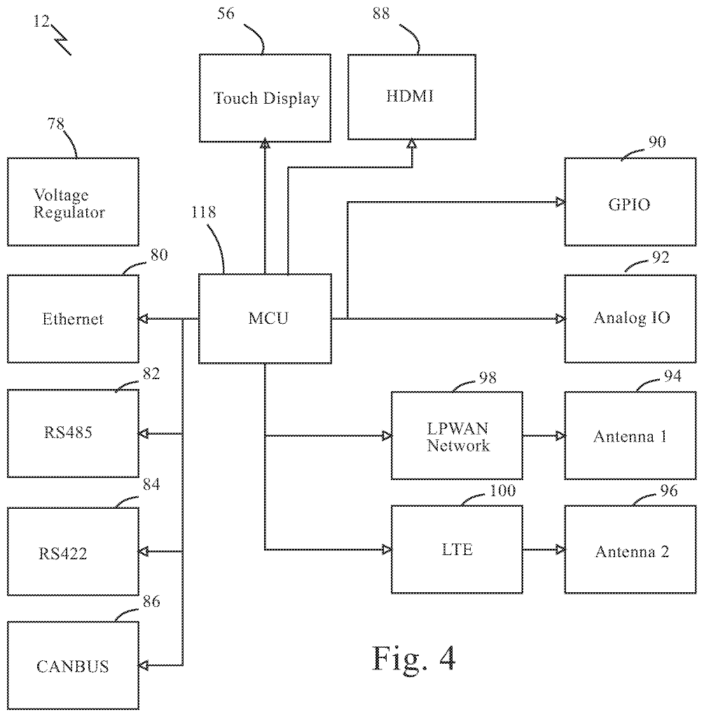

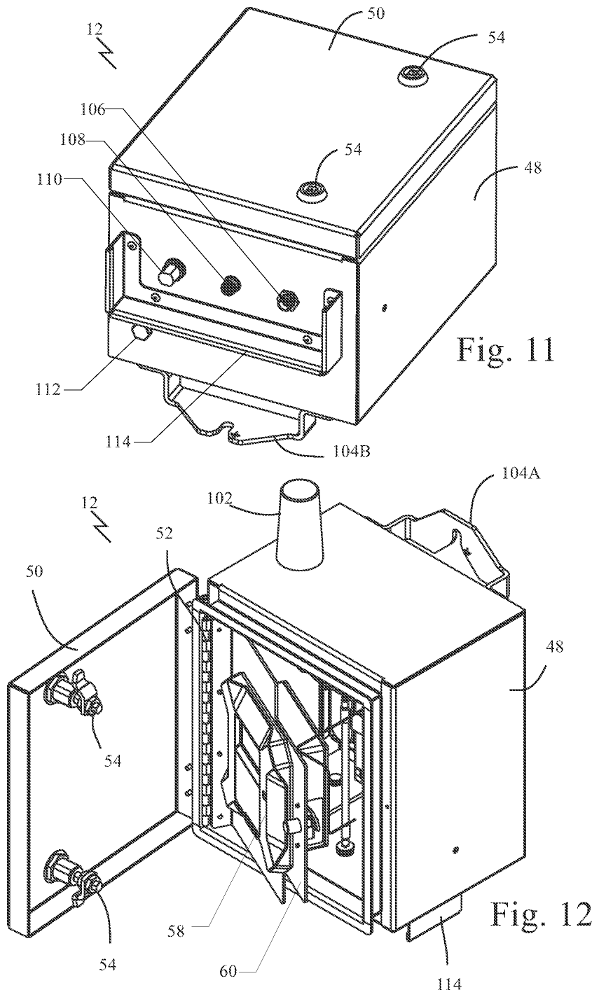

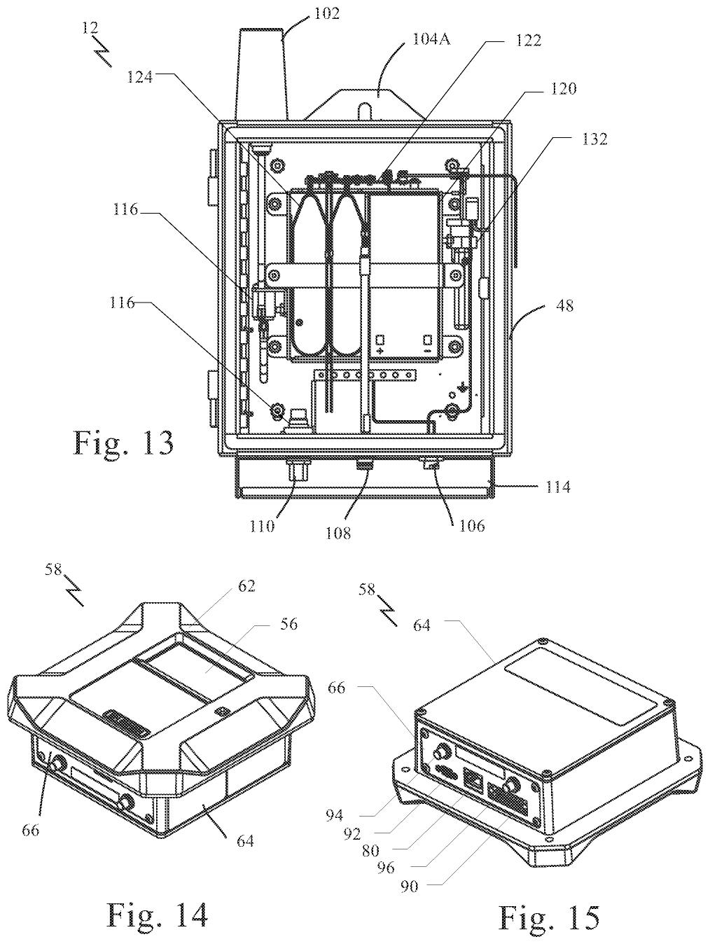

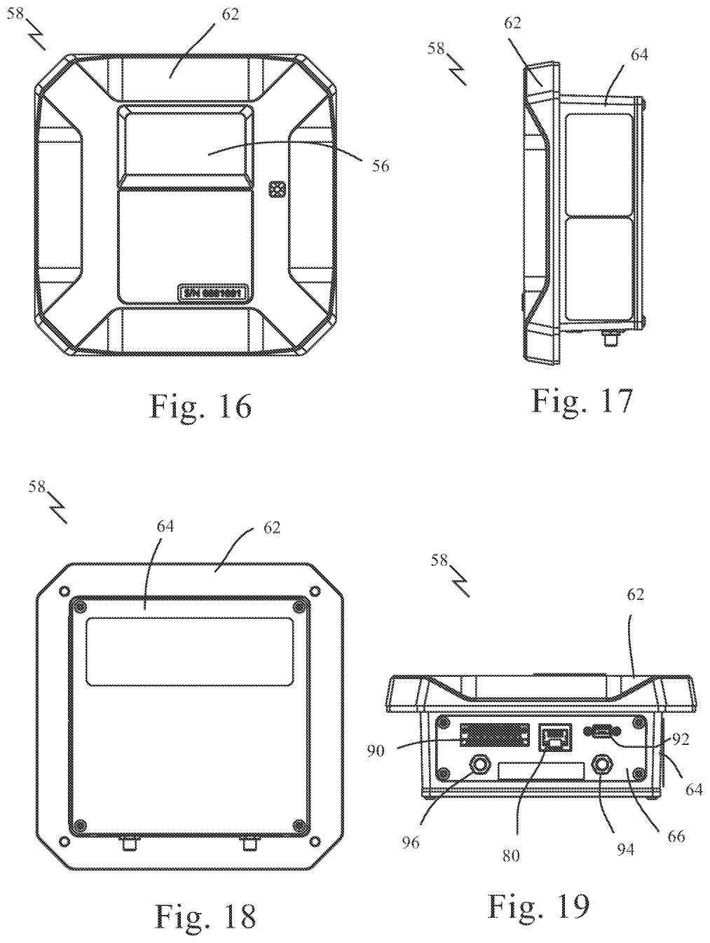

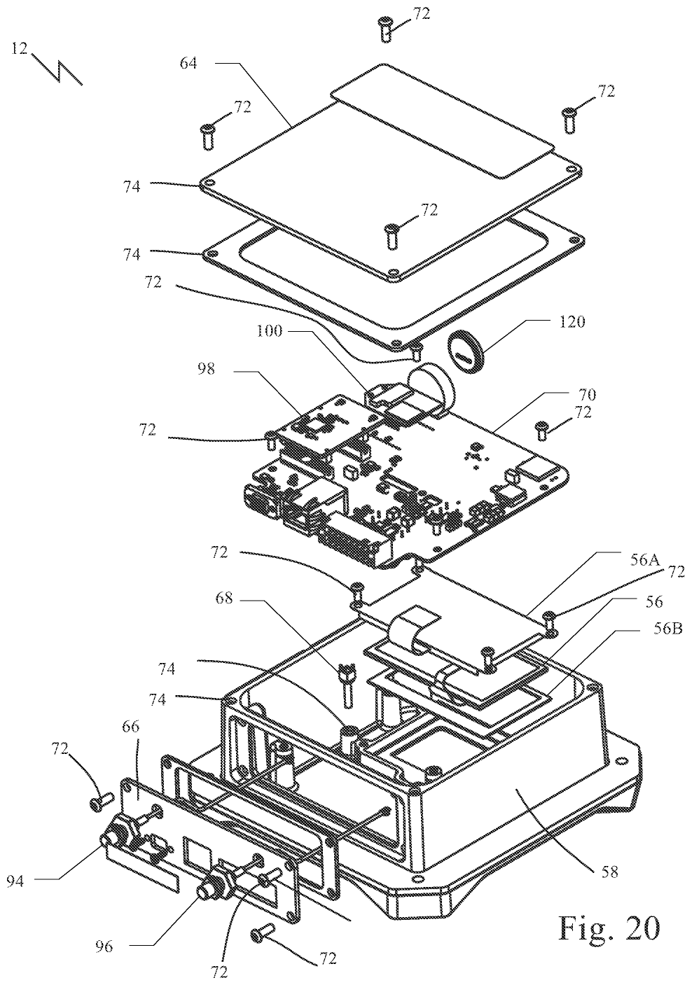

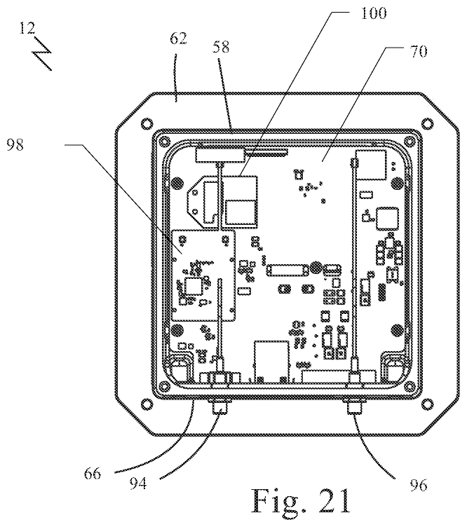

Referring to FIGS. 4 and 8-21, each node 12 may have suitable parts for achieving the desired functions and supporting the mesh network 20 as a participating node 12. An MCU (main computing or processing unit, referred to as processor 118) of a node 12 may have suitable characteristics, such as a CPU (Central Processing Unit), RAM (Random Access Memory), code storage and GPIO (General-purpose input/output) access. A voltage regulator 78 may be connected to convert external power input to a voltage that is useable by the electronics of the Smart Node 12. An ethernet connector 80 may be used for communications with other Ethernet enabled devices. Other serial bus connectors, such as connectors 82, 84, and 86, may be present. An RS485 serial connector 82, RS422 serial connector 84, and CANBUS (Controller Area Network Bus) serial connector 86 (may include USB (Universal Serial Bus) connectors) may each allow serial communications to communicate with third party sensors and devices. A GPIO 90 (for example a solar connector 106) may be provided to provide inputs and outputs for interfacing with third party equipment. One or more other inputs, such as a display input such as an HDMI connector 88 (High-Definition Multimedia Interface) may be provided. An analog IO 92 may be provided to provide inputs and outputs for analog signals. An LPWAN (Low-power Wide-area Network) modem 98 may be provided for short-range communications, for example a dual band 915 MHz band and 2.4 GHz band communications module may be provided for short-range low power communications. 915 MHz, 2.4 GHz, 902-928 MHz, ISM (Industrial, Scientific and Medical) bands, and other frequencies may be used. It should be noted that short-range communications may be defined as spanning, in the minimum sense, the distance between the nearest node 12, and in a maximum sense, the distance to the furthest node 12 in the subnet. In some cases, nodes 12 may be a mile apart, and may have a similar range of short-range communications capability. An LTE modem 100 may be provided for connection to LTE cellular networks. The modems 98 and 100 may connect with suitable antennas 94 and 96, respectively, as needed. Modem 100 and antenna 96 may collectively define a long-range transceiver 128. Modem 98 and antenna 94 may collectively define a short-range transceiver 126. One or more other features may be present, such as a data connector 108, a DNET™ (short-range network) antenna connector 110, a vent 112, and/or a lightning arrestor 116. A connector protective edge 114 may be present on housing 48.

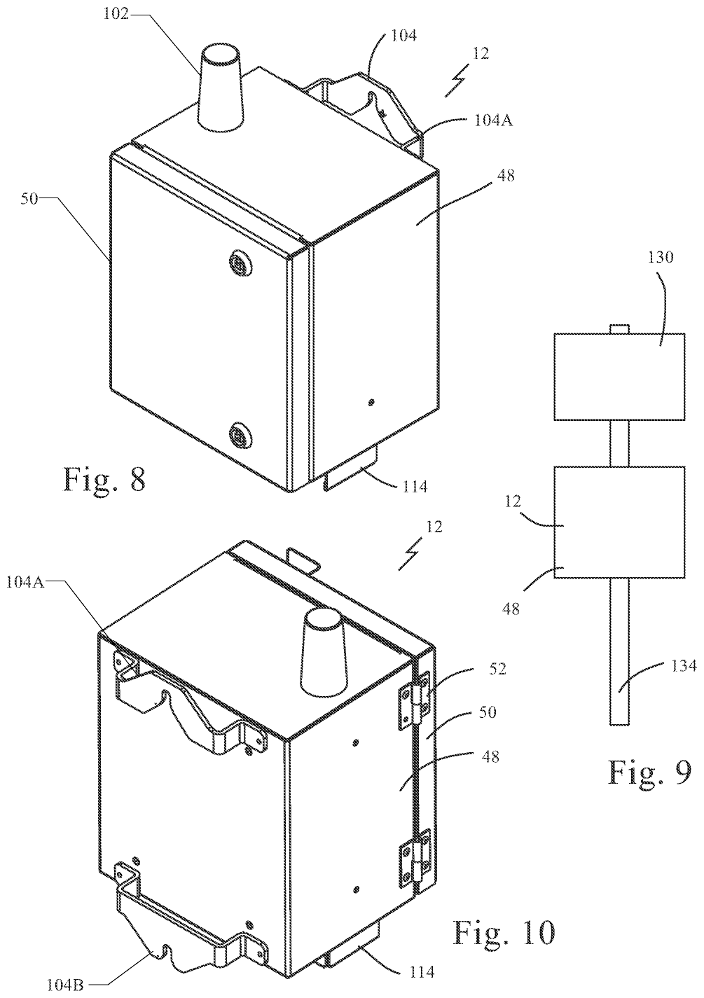

Referring to FIGS. 8-21, an example is shown of a node 12 suitable for field use. The node 12 may be contained in a suitable housing 48, for example an outer housing with a door 50. The door 50 may have a suitable lock 54, and may be hinged 52, or connected by other mechanisms. The node 12 may be mounted in a suitable fashion, for example mounted on a pole 134 (FIG. 9). Mounting may be achieved by a suitable method, such as using one or more brackets 104, such as an upper and lower mounting bracket 104A and 104B, respectively. Within the outer housing 48, an inner housing 58 may be provided to house the internal components of the node 12, for example the computing parts. The node 12 may have a suitable display 56, such as a touch screen display 56A. A gasket 56B may be provided to mount the display 56 while retaining a weather seal on the housing 58. The housing 58 may have a swing panel 60 and/or front cover door 62, and in some cases, a rear cover 64. A bottom panel 66, light pipe 68, fasteners 72, apertures 74 and/or a BTCv3™ PCB 70 may round out various other aspects of the node 12. A short-range to long-range linkage 85 may be provided. A node antenna 102 may be mounted or defined on the housing 48. The battery system may incorporate or be associated with one or more suitable elements, such as a battery bank 124, a sealed 12V (or other sized) battery 120, a battery switch interconnect PCT assembly 122, a solar charger 132, and a solar charger Sunkeeper™.

Referring to FIGS. 9, 15, 19, and 20, the node 12 may be configured to connect to a suitable power source. The power source of one or more of the plurality of nodes 12 may comprise a low-watt power source, such as a solar panel 130. The power source has an average energy production capacity of 15 W/hr or less daily, or another suitable capacity such as 10 W/hr or less, 5 W/hr or less, or higher or lower capacities. The average energy production capacity may be proportional to external factors, such as the time of day, terrain factors, the amount of sunlight exposed to the solar collector, the time of day, and the season. In some cases, two nodes 12 may have the same infrastructure, for example the same rating of solar collectors and battery capacity, however, the nodes 12 may assign a particular node 12 in preference if that node 12 has more power available to it by virtue of the aforementioned or other factors. Rankings for a particular node 12 may drift over time, for example as a result of changing topography (for example a sign is installed or a tree is added or removed within a sunlight path), or degrading or changing equipment capacities. The energy cost of long-range transmissions is higher than the energy cost of short-range transmissions, and thus the nodes 12 may cooperate to maximize efficiency and reliability of energy usage, and hence system functionality, on a whole. In some examples, a 50 W solar panel may be used. By providing a low power source of electricity, the cost of the node 12 decreases without decreasing utility. By contrast, if a node 12 were to be constructed for maximum battery performance, it might be coupled with a relatively high-power source, such as a 500 W solar panel, however, the additional cost is unnecessary in many of the embodiments disclosed herein.

Referring to FIGS. 1 and 3, the system 10 may communicate with a suitable back-end system 30. A back-end system 30 may comprise a server processor, such as server 32, 32A, and/or 32B, connected to receive and transmit communications from and to, respectively, the plurality of nodes 12 via the long-range network 18. A storage device 34 may be used, such as a computer readable medium for storing algorithms and data. The storage device 34 may store information in one or more databases. One or more displays 33 (and input devices, such as keyboards, mice, and others) may be connected in the system 30 to permit a developer or server operator to access and manipulate the back-end system 30. The system 30 may be located a substantial distance away from the network 20, for example 50, 100 or more miles away. In some cases, the system 30 may be located in a city or town, or in a different province, state, or country than the network 20. In some cases, a node 12 can hop 30-100 nodes. If a node 12 is used on every mile, hopefully in a 100-mile segment you would have at least one node with connectivity. If no connectivity is established over a suitable time, the node 12 may queue data for trying at another time, but such may be an indication that the user should build up the network further. Data may be dumped from memory after a certain period of time, for example 4 hours. Assuming that a train will move into the area, however, and data storage could be transported to a mobile station (i.e., the train), the mobile station could become a carrier for data to get to an area with long range connectivity. The server 32 may be connected to serve and relay communications information from the plurality of nodes 12 to third parties via the long-range network 18. In one case, the front-end server 32B may deliver usable forms and content, for example by JavaScript processes or other processes suitable for display in a web browser, accessible by the client or user, for example on a display 40 of a computer 38 of a client or user, or on a mobile phone 36 of the client or user. Thus, a user of the system 10 may use a phone 36 or computer 38 to monitor in real-time or near real-time the status of the network 20 and any relevant aspects within the network 20, for example the progress and integrity of track or train 22.

As shown in FIG. 1, the communications system 10 may have a plurality of track-side nodes 12, which are installed alongside a railway line or track. A plurality of gateway routers 26 may be installed periodically adjacent to the railway line or corridor 14, to facilitate communication between one or more adjacent nodes 12 and a long-range network 18, such as a cellular network. Alternatively, the long-range network 18 may be another form of long-distance wireless communication, such as a satellite network, or it may be a long distance wired communication network, such as a fibre-optic cable or copper wire network. When a locomotive (train 22) travels over a section of railway line in a remote region without access to a long-range network 18, such as in a gap in cellular coverage, the train 22 may wirelessly communicate with one or more nearby nodes 12. The node 12 relays the information to adjacent nodes 12 until the signal reaches a node 12 in range of the nearest gateway router 26. The signal is then transmitted to a data processing centre system 30, via the long-range network 18 where it can be analyzed and a response sent, if necessary.

Each node 12 may have a processor, a power source, and a wireless transceiver, which are mounted within a housing. Preferably, the power source is a battery charge by a solar cell mounted on or near the node 12. Other power sources may be used, where available, such as a wired power supply, a wind power generator, or other form of available harvested energy. The processor 118 may control the electrical components of the node 12 and may be mounted inside the housing 48. Preferably, the processor is a microcontroller unit (MCU) or central processing unit (CPU) installed on a printed circuit board (PCB) with the other electronic components of the node 12. The nodes 12 may also have a display 56 mounted within the housing 48. Preferably, the display 56 is a touch display, such as an OLED (Organic Light-emitting Diode) touch panel, to facilitate easy user interface for diagnostics, maintenance, or other such tasks. Other electrical components which may be mounted within the housing 48 of each node 12 include: memory, storage, and peripheral connections, such as USB or serial ports, or other types of data ports.

The wireless transceiver may use any suitable type of wireless communication, such as satellite communication, broadcast radio, microwave communication, cellular network, infrared communication, Bluetooth, Wi-Fi, mesh network, or other suitable type of wireless communication. Preferably, each node 12 may be capable of communicating with a cellular network for long distance communication (i.e., with the long-range network 18), via an IEEE™ (Institute of Electrical and Electronics Engineers) transceiver, and with a mesh network for short distance communication with adjacent nodes 12, via a low-frequency radio transceiver.

The use of a low-frequency radio transceiver for node-to-node communications provides a longer range for node-to-node communications and lower power consumption compared to many other types of wireless communication. Using this type of wireless transceiver to communicate node-to-node within the mesh network also permits fewer nodes to be used to cover long stretches of railway lines in remote regions where there are gaps in cellular coverage. The long-range of such a wireless transceiver also permits nodes 12 to communicate with non-adjacent nodes 12 and, thereby, provides some redundancy to the mesh network, in the event of a failure or communication error with one node 12. In the event of such a failure, the signal could “skip” the affected node 12 and thereby maintain communication between the other nodes 12 and the long-range network 18.

The gateway routers 26 are optional and, preferably, each node 12 has multiple wireless transceivers or a single wireless transceiver capable of multiple types of wireless communication to enable the nodes 12 to also perform the function of the gateway routers 26. Where gateway routers 26 are used, they are preferably installed on or with existing track-side communication equipment to facilitate communication over existing communication infrastructure. For example, a gateway router 26 could be installed where existing track-side equipment is already connected to a local power grid and wired (or wireless) communication network, to facilitate communication between nearby nodes 12 and the available connection to a long-range network 18, such as a fibre-optic network or cellular network.

Where gateway routers 26 are not used, each node 12 may be able to communicate via both short and long-distance wireless communication. Alternatively, only selected nodes 12, which are installed within range of a long-range network 18, may be configured for both short and long-distance wireless communication, to reduce the cost of nodes 12 located in gaps in cellular coverage. As a result, nodes 12 can operate both as a “local” node, communicating via the mesh network, and an “uplink” node, communicating via the long-range network 18. Nodes 12 may be assigned as either local nodes or uplink nodes (border routers) by the remote data processing centre system 30 or automatically. Local nodes may leave their long-distance wireless transceiver, such as a cellular modem, powered off to save power.

Preferably, uplink nodes are assigned automatically and dynamically by software running on each node 12 communicating over the mesh network. The software analyzes each node's 12 performance, based on a number of performance factors, to identify the best candidates for uplink nodes. The performance factors may include: battery performance, number of other nodes in communication range, cellular signal strength, number of other nearby candidate uplink nodes, distance to the nearest suitable candidate uplink node, or other relevant factors. For example, a node with consistently stronger cellular signal strength than other nodes would be a better candidate for an uplink node. Similarly, a node in range of more than one other node would be a better candidate, as would a node with consistently better battery performance (due to better positioning of its solar panel, etc.). The various performance factors may be weighted to produce an overall value that permits identification of the best candidate nodes.

The system may also periodically re-evaluate candidate nodes 12, and re-assign nodes 12 as local nodes or uplink nodes, when appropriate. For example, due to the additional power required for communication with the long-range network 18, an uplink node may drain its battery below a certain threshold, triggering another nearby local node to be re-assigned as an uplink node, at least until the former node can recharge its battery and resume service as an uplink node. In this way the system is able to dynamically assign uplink nodes to maintain optimal power consumption and a desired number of uplink nodes for optimal communications.

In operation, the system is installed track-side along a railway line to facilitate communication with a locomotive or other railway or track-side equipment. In one exemplary embodiment, the system may be used to facilitate communications for a train protection system, such as a positive train control (PTC) system. In such a system, information on track conditions ahead of a locomotive is sent to a control unit on the locomotive, which adjusts the speed of the train accordingly. Interruptions of communication with the locomotive's control system, such as occurs in remote areas with gaps in cellular coverage can compromise safety or train operations. For example, if track conditions ahead of a locomotive change after it enters a region of railway line in an area with a gap in cellular coverage, it may be too late for the control unit to safely slow the train by the time the locomotive exits the area and re-establishes communication. The communications system of the present disclosure provides an alternative method of communicating with the control unit on the locomotive in such remote areas to enable uninterrupted communication of information on track conditions.

If information on track conditions changes, such as in the event an emergency condition is detected, while the locomotive is out of communication contact with a long-range network the emergency condition would be transmitted to the nearest gateway router or uplink node, via the long-range network. The emergency condition would then be transmitted node-to-node, via the mesh network, until it reaches a node within communication range of the locomotive. The emergency condition is then transmitted, via the same type of wireless communication used between nodes, preferably a low-frequency radio transceiver, to the control system on the locomotive. The control system may then take appropriate action, such as applying the brakes, in response to the emergency condition, while the train is still within the region of railway line located in a gap in cellular coverage, before the locomotive is able to re-establish a direct connection with the long-range network. This provides vital additional time for the control system on the locomotive to respond to the emergency condition, thereby improving train safety and reducing the risk of derailments, collisions, or other serious incidents.

In addition to being used to facilitate communications with a long-range network in remote regions, the system may also be used to broadcast information locally within the mesh network. For example, if the system is connected with track-side sensors or other safety equipment to transmit that information to a data processing centre, the nodes or gateway routers may also have software to analyze the data from track-side sensors to determine if the data indicates an emergency condition. The system may then broadcast the emergency condition for a set number of node-to-node relays, from the node(s) detecting the condition, which may vary depending on the nature of the emergency condition. For example, a condition requiring a train to slow before passing through a certain section of track may be broadcast through the mesh network for a distance equal to the distance required for a train to slow from its normal travelling speed on that section of track to the reduced speed required by the track condition. This local signal may be broadcast, regardless of whether the signal is being transmitted to the data processing centre, via a gateway router or uplink node. This permits the control system on a locomotive to receive the information on the emergency condition even in the event of a communication failure between the system and the data processing centre.

The present disclosure has been described and illustrated with reference to an exemplary embodiment, however, it will be understood by those skilled in the art that various changes may be made and equivalents may be substituted for elements thereof without departing from the scope of the invention as set out herein. Therefore, it is intended that the invention not be limited to the particular embodiments disclosed herein.

TABLE 3
Table of parts

10 - A communication system
12 - Track- side nodes
14 - remote transport corridor
16 - geographical area
18- long-range network/cellular network
20 - wireless mesh network/short range
network
22 - train locomotive
24 - border router
26- gateway routers
28 - sensors
28A - sensing collector
30 - data processing center/back end
32 - Server Processor
32A - backend server
32B - front end server
33 - server display
34 - storage
36 - user cell phone
38- user computer
40 - user display
42 - gap in coverage
44 - satellite network
46 - internet
48 - outer housing
50 - door of housing
52 - hinges of housing
54 - locking mechanisms
56 - display
56A - display of touch screen
56B - gasket of touch screen
58 - internal housing
60 - swing panel of internal housing
62 - front cover/housing
64 - rear cover
66 - bottom panel
68 - Light pipe
70 - BTCv3 PCA
72 - fasteners
74 - posts/apertures
76 - short range to long range linkage
78 - voltage regulator
80 - Ethernet connector
82 - RS485 connector
84 - RS422 connector
86 - CANBUS connector
88 - HDMI connector
90 - GPIO input outputs/16J - power/data
92 - analog IO
94 - Antenna 1/16E - DNET Antenna
96 - antenna 2/16H - LTE antenna
98 - LPWan/Dual band radio board
100 - LTE modem
102 - node antenna
104 - mounting bracket
104A - upper mounting bracket
104B - lower mounting bracket
106 - solar connection
108 - data connection
110 - DNET antenna connection
112 - vent
114 - connector protective edge
116 - lightning arrestor
118 - node processor
118A - message builder
118B - dispatching manager
118C - long range comm controller
118D - dynamic border router manager
118E - short range comm controller
118F - energy manager
118G - operational metric collector
118H - short range link quality reporter
118J - message traffic density reporter
118K - long range link quality reporter
120 - node battery
120A - capacity reporter
122 - battery switch interconnect PCB
assembly
124 - node battery charge power source
126 - short-range transceiver
128 - long range transceiver
130 - solar panel
130A - capacity reporter
132 - solar charger sunkeeper
134 - pole

In the claims, the word “comprising” is use in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

The embodiments of the Invention in which an Exclusive Property or Privilege is claimed are Defined as Follows:

1. A communications system comprising:
a plurality of nodes distributed within a geographical area, each of the plurality of nodes being in communication with one or more of the other of the plurality of nodes to collectively form at least a partially-connected wireless mesh network; and
each of the plurality of nodes having:
a node processor;
a battery;
a connection to a power source;
a short-range transceiver for short-range communications between nodes of the plurality of nodes; and
a long-range transceiver for long-range communication with a long-range network; and
in which each of the plurality of nodes are configured to dynamically assign and use one or more of the plurality of nodes as a border router.

2. The communications system of claim 1 in which the plurality of nodes comprise one or more gateway routers.

3. The communications system of claim 2 in which the one or more gateway routers are characterized by superiority relative to the other of the plurality of nodes, of one or more of battery performance, long-range link quality, power source capacity, power source permanence, and a wired connection to the long-range network.

4. The communications system of any one of claim 2-3 in which:
in a first mode, each of the plurality of nodes assign and use one or more gateway routers as the border router in preference to the other of the plurality of nodes; and
in a second mode, each of the plurality of nodes assign and use another of the plurality of nodes as a border router when a ranking of the gateway router drops below a predetermined threshold or a ranking of the another of the plurality of nodes.

5. The communications system of any one of claim 1-4 in which each of the plurality of nodes are configured to dynamically assign a border router for the node based on rankings dynamically assigned to each of the plurality of nodes.

6. The communications system of claim 5 in which a ranking of each node is based on one or more of the following performance characteristics: a battery capacity, battery performance, available charging capacity, long-range link quality, microcontroller unit (MCU) utilization, number of other nodes in communication range with the node, number of other nearby candidate border routers, distance to the nearest suitable candidate border router, long-range network load, and short-range bandwidth.

7. The communications system of claim 6 in which the ranking of each node is based on at least battery capacity, available charging capacity, and long-range link quality.

8. The communications system of any one of claim 6-7 in which each of the plurality of nodes are configured to broadcast, to other of the plurality of nodes, performance characteristics of the node at periodic intervals or as a result of a change in performance characteristics.

9. The communications system of any one of claim 7-8 in which each of the plurality of nodes are configured to self-rank and broadcast a self-ranking for the node to other of the plurality of nodes.

10. The communications system of claim 9 in which each of the plurality of nodes are configured to dynamically assign and use one or more of the plurality of nodes as a border router based on the rankings provided by each of the plurality of nodes and a short-range link quality to each of the plurality of nodes.

11. The communications system of claim 10 in which:
there are a plurality of border routers available for a node; and
the plurality of nodes are configured to failover to other of the plurality of border routers when a first of the plurality of border routers is instructed, and fails, to send a long-range transmission through the long-range network.

12. The communications system of any one of claim 1-11 in which, in the event of a border router being instructed, and failing, to send data through the long-range network, one or more of the plurality of nodes storing and subsequently re-attempting to send or instruct the sending of the data.

13. The communications system of any one of claim 1-12 in which the power source of one or more of the plurality of nodes comprises a low-watt power source.

14. The communications system of any one of claim 1-13 in which the power source has an average energy production capacity of 15 W/hr or less daily.

15. The communications system of any one of claim 1-14 in which the power source comprises a solar panel.

16. The communications system of any one of claim 1-15 in which each of the plurality of nodes comprises a housing and is mounted above-ground on a pole.

17. The communications system of any one of claim 1-16 in which the long-range wireless network comprises one or more of the internet, a cellular network, and a satellite network.

18. The communications system of any one of claim 1-17 in which the geographical area comprises a transport corridor.

19. The communications system of claim 18 in which the transport corridor comprises a railway track for a train.

20. The communications system of claim 19 in which the plurality of nodes are configured to maintain a train on the railway track in continuous communication with the long-range wireless network.

21. The communications system of any one of claim 1-20 in which the geographical area comprises a remote geographical area with portions or the entirety of which being out of contact with a cellular network other than via one or more border routers.

22. The communications system of any one of claim 1-21 in which the long-range transceiver comprises one or more of: a cellular transceiver, a satellite transceiver, a broadcast radio transceiver, and a microwave transceiver.

23. The communications system of any one of claim 1-22 in which the short-range transceiver comprises one or more of a low frequency radio transceiver, an infrared transceiver, a Bluetooth transceiver, a Wi-Fi transceiver, and a mesh network transceiver.

24. The communications system of any one of claim 1-23 in which the short-range transceiver comprises a low frequency 2.4 GHz or 915 MHz wireless radio transceiver.

25. The communications system of any one of claim 1-24 further comprising a back-end system comprising a server processor connected to receive and transmit communications from and to, respectively, the plurality of nodes via the long-range network.

26. The communications system of claim 25 in which the server processor is connected to serve and relay communications information from the plurality of nodes to third parties via the long-range network.

27. The communications system of any one of claim 1-26 further comprising a plurality of sensors connected to provide information to the plurality of nodes.

28. The communications system of claim 27 in which the plurality of sensors are configured to sense and provide information on one or more of motion, temperature, vibration, tilt, rail or corridor integrity, seismic activity, humidity, water levels, weather, flooding, proximity, obstacle, wildlife, sound and visual elements.

29. A method comprising:
using a plurality of nodes to communicate with each other in a partially-connected mesh network and dynamically assign one or more of the plurality of nodes as a border router, in which the plurality of nodes are distributed within a geographical area; and
using the border router to relay communications from the plurality of nodes through the long-range network.

30. The method of claim 29 in which:
the plurality of nodes comprise one or more gateway routers;
in a first mode, each of the plurality of nodes assign and use one or more gateway routers as the border router in preference to the other of the plurality of nodes; and
in a second mode, each of the plurality of nodes assign and use another of the plurality of nodes as a border router when a ranking of the gateway router drops below a predetermined threshold or a ranking of the another of the plurality of nodes.

31. The method of any one of claim 30 in which each of the plurality of nodes are configured to dynamically assign a border router for the node based on rankings dynamically assigned to each of the plurality of nodes.

32. The method of claim 31 in which a ranking of each node is based on one or more of the following performance characteristics: a battery capacity, battery performance, available charging capacity, long-range link quality, microcontroller unit (MCU) utilization, number of other nodes in communication range with the node, number of other nearby candidate border routers, distance to the nearest suitable candidate border router, long-range network load, and short-range bandwidth.

33. The method of claim 32 in which the ranking of each node is based on at least battery capacity, available charging capacity, and long-range link quality.

34. The method of any one of claim 32-33 further comprising, each of the plurality of nodes broadcasting, to other of the plurality of nodes, performance characteristics of the node at periodic intervals or as a result of a change in performance characteristics.

35. The method of any one of claim 30-34 further comprising, each of the plurality of nodes self-ranking itself and broadcasting a self-ranking for the node to other of the plurality of nodes.

36. The method of any one of claim 30-35 further comprising, at one of the plurality of nodes:
assigning one of the other of the plurality of nodes as a border router based on the rankings provided by each of the plurality of nodes and a short-range link quality to each of the plurality of nodes; and
transmitting a message to the border router.

37. The method of any one of claim 30-36 in which, there are a plurality of border routers available for a node, and further comprising:
attempting to transmit data by one of the plurality of border routers; and
in the event of failure, attempting to transmit data by subsequent of the plurality of border routers.

38. The method of claim 37 further comprising, in the event of no other suitable border router being located or all possible border routers failing to transmit the data, storing and subsequently re-attempting to send or instruct the sending of the data.

39. The method of any one of claim 29-38 further comprising transmitting a message off-network through the long-range network via a border router.
